(19) United States
(12) Patent Application Publication
(10) Pub. No.: US 2008/0217874 A1
(43) Pub. Date: Sep. 11, 2008

(54) Active air suspension for mobile liquid tanks

(76) Inventor: Mark R. Miskin, Alta, WY (US)

Correspondence Address: MORRISS OBRYANT COMPAGNI, P.C., 734 EAST 200 SOUTH, SALT LAKE CITY, UT, 84102, US

(21) Appl. No.: 11/713,916

(22) Filed: Mar. 5, 2007

(51) Int. Cl. B60G 17/00

(52) U.S. Cl. 280/6.151; 280/766.1

(57) ABSTRACT

Apparatus, systems and methods for the stabilization of a mobile liquid tank during transportation of a liquid. Sensors feed information regarding the status and position of a liquid retained therein to a control unit which calculates expected movement of the liquid, and controls a set of pneumatic valves to adjust airsprings of a pneumatic suspension as to minimize undesirable movement of the liquid.

### TECHNICAL FIELD

The present invention relates generally to suspensions for motorized vehicles and trailers. More specifically, the present invention relates to active suspensions for vehicles and trailers for transporting fluids in a mobile tank, where the suspension components are actively controlled to respond to motions of the transported fluid.

### BACKGROUND

Rollover is unfortunately a common problem with mobile tankers, due to the height and narrow width. The reasons for rollover have been studied, one example of such a study is set forth in Winkler, C. Rollover of Heavy Commercial Vehicles, UMTRI research Review, pages 1-20, October-December 2000, which is incorporated by reference herein in its entirety. The traditional approaches to reducing rollover include sway-bars, and sensor monitoring of pitch, with a display presented to the driver or electronic control to limit acceleration of the vehicle. Where a liquid containing tank is present on a trailer, the problems may become more pronounced.

Mobile tanks are often fastened to a frame, such as a trailer or a railroad car, for use in transporting liquids. During transportation, the liquids in a mobile tank are always moving. As the liquid moves it causes the center of gravity of the load to change and results in instability, which can lead to a tip-over or to dangerous loss of control over the transported tank. In theory, a mobile tank could even tip over traveling in a straight line on flat ground, if the there are bumps at the right locations to cause a buildup of side-to-side wave action.

There are generally two stability problems in transporting a fluid in a mobile tank. Although there is overlap between the two general categories. The first is the formation of“waves” in the transported fluid and the other is the sloping of the fluid due to inertia during movement of the tank.

Traditionally, these problems have been dealt with by placing baffles in a tank. One example of a mobile tank for transporting liquids that contains a baffle is that disclosed in U.S. patent application Ser. No. 10/690,764, filed Oct. 22, 2003 and entitled Methods of Tank Construction, which is incorporated herein by reference in its entirety. Basically, a baffle works by restricting movement of the liquid in a tank to individual sections of the tank and/or by dispersing a wave or slope by physically blocking its generation or movement. While baffles reduce the effects of motion on the transported liquid, the reduction may not be sufficient to avoid additional stress on the tank or trailer. Baffles also reduce the holding capacity of a tank and are not capable of adjusting to interact in the best possible way with different fluids that may be carried at different times in the same tank.

Thus, apparatus, systems and methods that provide ways of actively reducing the effects from the motion of liquids in a mobile tank would be an improvement in the art.

### SUMMARY

The present invention provides apparatus, systems and methods for the stabilization of a mobile liquid tank during transportation of a liquid. Sensors feed information regarding the status and position of a liquid retained therein to a control unit, which may be an on-board computer. Other information, including acceleration/deceleration, travel speed, steering, centrifugal force from turns, slope, GPS, and radar to sense the topography of the terrain not yet traveled may be similarly be monitored and input. The control unit calculates the expected movement of the liquid, and controls a set of pneumatic valves to adjust airsprings of a pneumatic suspension as to minimize undesirable movement of the liquid. In an emergency the airsprings may be deflated, lowering the entire tank to lower the center of gravity reduce the likelihood of the tank tipping over.

### DESCRIPTION OF THE DRAWINGS

It will be appreciated by those of ordinary skill in the art that the elements depicted in the various drawings are for exemplary purposes only. The nature of the present invention, including the best mode, as well as other embodiments of the present invention, may be more clearly understood by reference to the following detailed description of the invention, to the appended claims, and to the several drawings.

FIG. 1 is back view of one illustrative embodiment of a mobile tank disposed on a trailer and including a stabilization control system in accordance with the present invention.

FIG. 2 is a side view of another illustrative embodiment of a stabilization system in accordance with the present invention.

FIG. 3 is a front view of an illustrative embodiment of a portion of a stabilization system in accordance with the present invention.

FIG. 4 is a schematic view of a stabilization system including at least one sensor and a control unit, in accordance with the present invention.

### DETAILED DESCRIPTION

The present invention relates to systems and methods for stabilizing a mobile tank for transporting liquids during transport with the tank. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention. Similarly, while the drawings depict illustrative embodiments of devices and components in accordance with the present invention and illustrate the principles upon which the depicted device or component is based, they are only illustrative and any modification of the invented features presented herein are to be considered within the scope of this invention.

Movement of liquids in a tank may be predicted mathematically. For example, the sloshing behavior in a liquid cargo tank has been studied with respect to tanker ships for marine transport of liquids, such as oil and gas. One paper addressing such simulations is Mikelis, N. E. et al., Experimental and Numerical Simulations of Sloshing Behaviour in Liquid Cargo Tanks and its effects on Ship Motions, National Conference on Numerical Methods for Transient and Coupled Problems, 9-13 Jul. 1984, Venice, Italy, Report 0661-P, 1984 Delft University of Technology, the disclosure of which is incorporated by reference herein. As set forth therein, numerical modeling using the “marker and cell” technique (where Navier-Stokes equations are solved for each “cell” of a computational mesh corresponding to a partially filled tank) allows for transient fluid flow problems to be addressed. Comparison of the predicted sloshing movements of the liquid and the effect on the tank containing the liquid were compared to actual data obtained by experimental measurement, and were found to show good agreement. Other suitable techniques for predicting the movement of liquid in a tank are known to those of skill in the art and may be used in systems in accordance with the present invention.

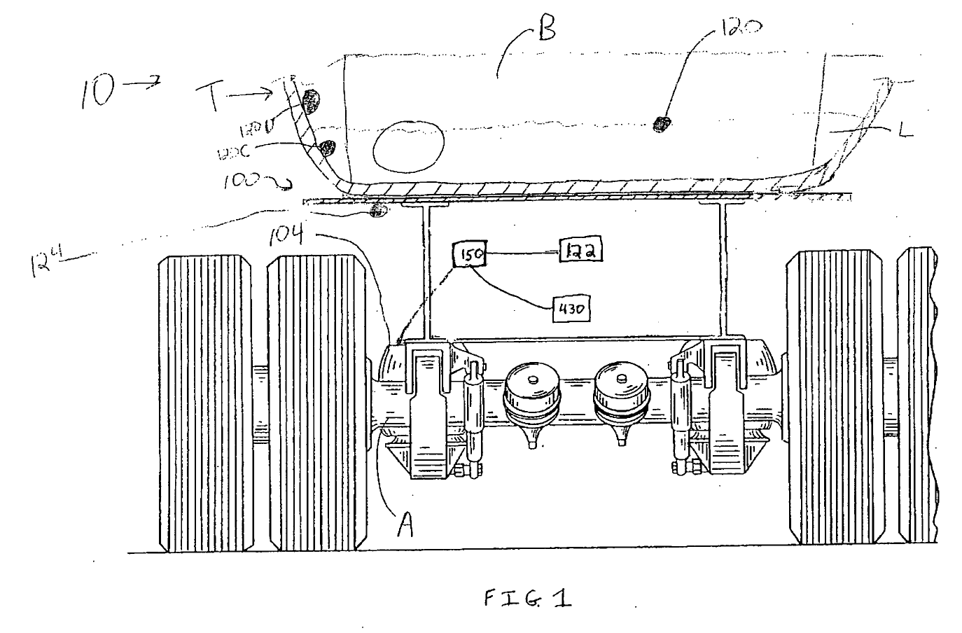

Turning to FIG. 1, a mobile tank system 10, including an active stabilization system in accordance with the present invention is depicted. A mobile tank T is disposed on a trailer 110, which may be a trailer designed for over the road (OTR) towing by a semi as part of a tractor-trailer system. The tank T may be any desired shape, such as polygonal, tubular, ovoid, etc and is designed for the transportation of liquids. A baffle B may be disposed in the tank T, to compartmentalize the tank T or to physically disperse movement of liquid retained therein. Trailer 110 and tank T may be separate units, such as flat bed trailer to which a tank is attached, may be formed as an integral unit, where the tank forms a portion of the trailer, or the may be formed as a tank built around a trailer frame, thus sharing common structural elements (as where the baffle B is part of the framework of the trailer). It will be appreciated that the tank T and trailer 110 may be a preexisting trailer, as commonly used today, which has been fitted with a system in accordance with the present invention.

Disposed in the tank T are a number of sensors 120. The number of sensors 120 used may vary based on the size and shape of tank T, so long as sufficient sensors 120 are used to allow for monitoring and prediction of movement of liquid retained in the tank T. The sensors 120 may be pressure sensors, motion sensors, or other types of sensors useful for sensing the presence, the pressure, and/or the motion of a liquid retained in the tank T. The specific type of sensor used may vary based on the liquids intended for placement in the tank T. Combinations of different sensor types may also be used.

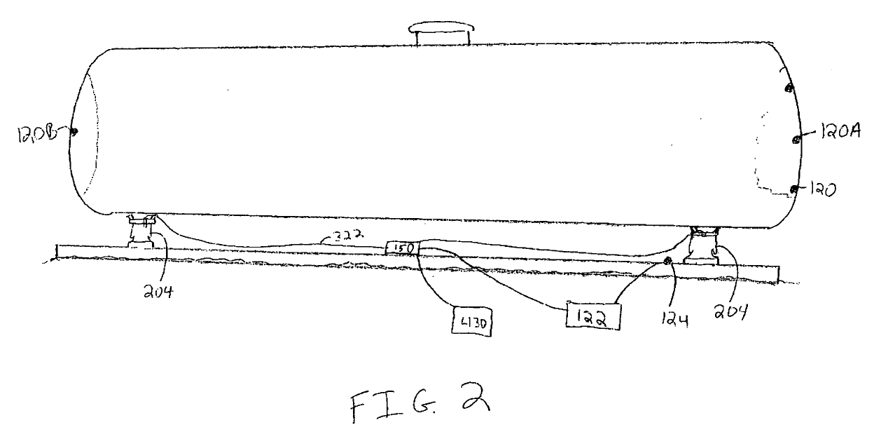

The placement of the sensors 120 may vary based upon the shape of the tank T, in order to allow for accurate prediction. For example, sensors 120A and 120B may be placed at opposite ends of the tank T to detect pressure differences and motion therebetween (FIG. 2). Similarly, sensors 120, such as those designated 120C and 120D may be placed at varying heights along the walls (or at the ends) of tank T to detect pressure or motion in retained liquid at various depths. Sensors 120 may also be placed on the baffle, B, where present.

Using the sensors 120, the condition and motion of liquid L retained in the tank may be detected. The information obtained by the sensors 120 is provided to a control unit, represented by box 122. Control unit 122 may be a computer or a microprocessor onboard the trailer 110 or in a prime mover for operating the trailer 110. Where the sensors 120 include electronic sensors, the detected information may be directly provided to the control unit 122 over an electrically communicative connection therebetween, as by an electrically conductive cable. Alternatively, the electronic sensors could provide the information using an appropriate wireless transmission protocol, such as WAP, Bluetooth, etc.

The control unit 122 may be a computer which runs a program, typically by executing lines of code contained in software loaded therein. The control unit 122 predicts the behavior of liquid retained in the tank T, by analyzing data provided to it by the sensors 120 and numerically predicting the expected motion of the liquid based on such data. This monitoring and prediction will occur on a continuous basis when the system is in use.

In addition to sensor 120 disposed within the tank, additional sensors 124 may be placed on the trailer or a prime mover at various locations to detect the motion and position of the trailer 110, or the future motion of the trailer 110. Such sensors 124 may include cameras, motion sensors, inclinometers, ground scanning radar, GPS receivers, etc, for monitoring the conditions around the trailer and predicting motion thereof, or other such sensors as known in the art, as for example those described in the Winkler paper previously cited herein. Additionally, where the prime mover attached to the trailer 110 has an onboard computer system, such as a semi tractor with an onboard computer for controlling electronic engine or other components, information from the onboard computer regarding speed, acceleration, deceleration, turning, etc. may be provided to the control unit 122 over a communicative connection. Using such sensors 124, acceleration/deceleration, travel speed, steering, centrifugal force from turns, slope, GPS, and the topography of the terrain not yet traveled may be provided.

As the control unit 122 predicts movement of liquid inside the tank T, it controls a series of valves, represented by box 150, to inflate and deflate pneumatic airsprings 104 in a suspension system, in order to counter the predicted motion of the liquid. It will be appreciated that valves 150 may be any suitable valves for controlling the inflation or exhaust (deflation) of an airspring 104 with an electronic control unit and that a single valve may be used for control of each individual airspring 104. As depicted in FIG. 1, the suspension may be part of a standard trailer suspension system which includes pneumatic airsprings 104 between an axle A and the body of the trailer 110. Preferably, such a suspension will include at least two airbags associated with each axle A of the trailer (one at either end of the axle where one or more wheels are attached to the axle A). It will be appreciated that systems in accordance with the present invention may be used with suspension systems where more airsprings 104 are associated with each axle A. In such embodiments, finer control over the suspension system may be achieved.

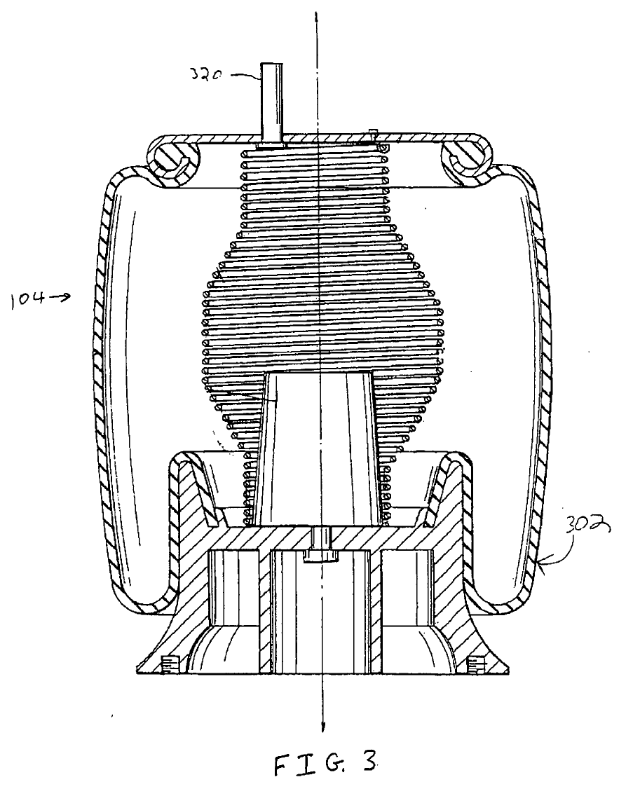

Airsprings 104 may be airbags designed for used as springs in automotive, train, tractor-trailer, and other vehicular suspension systems. As depicted in FIG. 3, typically, airsprings 104 include a bellows 302 attached to one or more plates. Physical connections may be made to the plates or the pistons of the airbags through connection bolts disposed therein. Currently, airsprings are available in reversible sleeve (piston) and single, double or triple convoluted conformations, any of which may be used with embodiments of the present invention. Suitable airsprings are available from FIRESTONE and other suspension component manufacturers. These may be used in the present invention as well.

It will be appreciated that where each airspring 104 may be considered a pneumatic spring configured as a column of gas (air) confined within a container. The pressure of the confined gas, and not the structure of the container, acts as the force medium of the spring. A wide variety of sizes and configurations of airsprings are available, including sleeve-type airsprings, bellows-type airsprings, convoluted-type airsprings, rolling lobe airsprings, etc. Such airsprings commonly are used in both vehicular and industrial applications. Airsprings, regardless of their size and configuration, share many common elements. In general, an airspring includes a flexible, sleeve-like member made of fabric-reinforced rubber that defines the sidewall of an inflatable container. Each end of the flexible member is closed by an enclosure element, such as a bead plate that is attached to the flexible member by crimping. The uppermost enclosure element typically also includes air supply components and mounting elements (e.g., studs, blind nuts, brackets, pins, etc.) to couple the airspring to the vehicle structure. The lowermost enclosure element also typically includes mounting elements to couple the airspring to the vehicle axle. Examples of airsprings are set forth and discussed in U.S. Pat. No. 6,957,806, the disclosure of which is incorporated by reference herein.

As best depicted in FIG. 3, attached to each airspring 104 is a fitting 320 to which an air hose 322 and a valve 150 may be functionally attached. These structures may be used to inflate and deflate each airspring 104. As discussed previously herein, valve 150 may include an exhaust, or a separate exhaust may be included for deflation of the airspring 104.

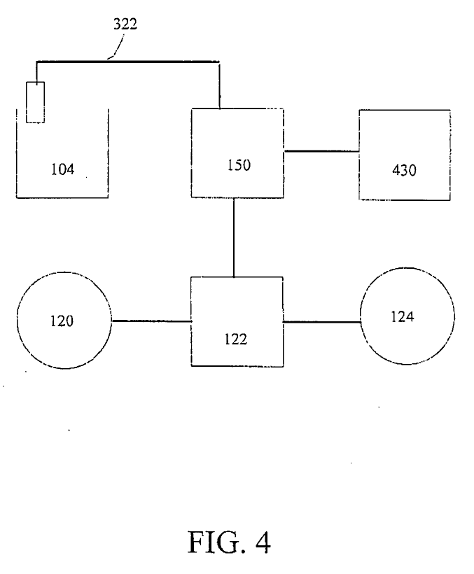

The air hose 322 is attached to a gas source 430 (FIG. 4), such as an air compressor or a tank holding compressed air. The gas source may be an air compressor located on a prime mover attached to the trailer 10. Connection to the air compressor may be made through airlines also providing air to air brakes on the trailer 110 (which may be through a system including a compressed air reservoir tank). It will be appreciated that a system in accordance with the present invention may be made available as an assembly for installation (such as aftermarket installation) on pre-existing trailers or tanker trucks.

Where the tank T is located on a truck (such as a “straight-truck”), or on an earth moving apparatus that is self-propelled implement, an air compressor located thereon and powered by an onboard engine may provide the gas to the airbag 104.

As depicted in FIG. 1, the airsprings 104 may be part of a suspension system attached to the axles A of a trailer 110 for absorbing or responding to forces generated by the movement of the trailer 110, including tires on wheels attached to the axles A interacting with the ground surface.

As depicted in FIG. 2, an alternative suspension system 20 may be disposed between the tank T and the trailer 210. Trailer 210 may be a trailer for towing by a prime mover, such as a semi-tractor or an agricultural or construction tractor (or other self-propelled construction equipment) over a ground surface, such as road surface or a ground at a construction site. Such embodiments may include axles, and wheels for attachment to rims and tires as may be appropriate. Alternatively, the trailer 210 may be a railroad car including axles and wheels configured for interaction with the rails of a railroad track, and coupling attachments for attachment to other railroad cars or a prime mover, such as a train engine car.

The suspension system 20 includes at least one airsprings 204 disposed between the tank T and the trailer 210. It is presently preferred that multiple airsprings 204 be used. In one illustrative embodiment, at least four airsprings 204 are used. Each airspring 204 may be positioned such that its inflation will elevate a section of the tank, such as a corner or a quarter of the tank, where four airsprings 204 are used.

As the control unit 122 predicts movement of liquid L inside the tank T, it controls a series of valves 150 to inflate and deflate pneumatic airsprings in a suspension system, in order to counter the predicted motion of the liquid L. Where the control unit 122 predicts that movement of the liquid L is forming a “side slope” in the tank, the control unit 122 will activate the appropriate valves 150 to move the tank by lowering the “uphill” side, and raising the “downhill” side relative to one another, making the tank more stable. Where the control unit 122 predicts the formation of waves in the tank, whether “side-to-side,” “front-to rear” or a combination thereof, the control unit 122 will activate the appropriate valves 150 to adjust the tank in a manner to dampen the waves. Where the control unit 122 predicts movement of the liquid L from cornering of the tank in motion, the control unit 122 may activate the appropriate valves 150 to lower the side of the tank T on the inside of the turn and raise (or firm) the outside of the tank T, relative to one another, thus tipping the top of the tank T inward and resulting in better stability through the turn.

It will be appreciated that the active suspension systems 10 of the present invention may be continually monitoring and responding to the motion and predicted motion of liquid in the tank T during transportation of the tank.

FIG. 4 depicts a schematic of a stabilization system in accordance with the present invention. While reference is made to numerals in FIGS. 1, 2 and 3 for clarity, it will be appreciated that other embodiments of active tank stabilization systems, including pneumatically operated and hydraulically operated systems, in accordance with the present invention are contemplated and considered within the scope of the present invention.

One or more sensors 120 and 124 may be disposed on the tank T and trailer or vehicle on which the tank T is mounted. These sensors may be motion sensors, pressure sensors or other sensors as previously discussed herein. Such sensors may provide output in the form of electrical signal that may be digitally read by a computer to determine a parameter regarding the motion of the tank T or the movement of liquid L retained in the tank T. During use, a control unit 122, such as an onboard computer system, monitors the conditions reported by the sensor(s) 120 and/or 124. As movement of liquid L inside the tank T is predicted, a series of valves 150 are actuated to inflate and deflate pneumatic airsprings in a suspension system, in order to counter the predicted motion of the liquid L, as discussed previously herein.

In this way, the effect of “sloshing” liquid in the tank T can be reduced. It will be appreciated that the control system 122 may be further configured to deflate all the airsprings 104, upon the sensors 122 reporting conditions that may signal potential rollover danger for the trailer or vehicle o which the tank T is mounted. This may lower the entire tank T and reduce the center of gravity for the mass, reducing the tendency of the tank T to rollover.

While this invention has been described in certain illustrative embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for stabilizing a mobile liquid tank, the system comprising:
at least one sensor disposed in a mobile tank;
a control unit in communicative contact with the at least one sensor, the control unit configured to predict motion of liquid retained in the mobile tank in response to data acquired from the at least one sensor;
at least one valve in communicative contact with the control unit; and
at least one pneumatic airbag in a suspension system in operative connection to the tank, such that inflation of the at least one pneumatic airbag raises or lowers a portion of the mobile tank.

2. The system of claim 1, wherein the at least one sensor disposed in a mobile tank comprises two or more sensors disposed in the mobile tank.

3. The system of claim 2, wherein two or more sensors disposed in the mobile tank comprise at least two sensors mounted opposite one another on opposite sides of the tank.

4. The system of claim 1, wherein the at least one sensor disposed in a mobile tank comprises a pressure senor or a motion sensor.

5. The system of claim 1, further comprising at least one sensor mounted on a carrier to which the mobile tank is mounted.

6. The system of claim 5, wherein the at least one sensor mounted on a carrier to which the mobile tank is mounted comprises a camera, a motion sensor, an inclinometer, a ground scanning radar sensor, or a GPS receiver.

7. The system of claim 1, wherein the mobile tank is mounted on a trailer configured for towing by a semi tractor.

8. The system of claim 1, wherein the at least one pneumatic airbag in a suspension system comprises a pneumatic airbag disposed in a suspension system between an axle and a carrier on which the mobile tank is mounted.

9. The system of claim 1, wherein the at least one pneumatic airbag in a suspension system comprises a pneumatic airbag disposed in a suspension system the mobile tank and a carrier on which the mobile tank is mounted.

10. The system of claim 1, wherein the at least one pneumatic airbag in a suspension system comprises at least four pneumatic airbags, each disposed to raise a portion of the tank relative to one another upon inflation thereof.

11. A method of stabilizing a mobile liquid tank during transport, the method comprising:
monitoring an aspect of a liquid retained in the mobile liquid tank;
predicting expected motion of the liquid retained in the mobile liquid tank based on the monitored aspect of the liquid; and
inflating at least one pneumatic airbag to raise a portion of the mobile liquid tank to counter the predicted expected motion of the liquid.

12. The method according to claim 1 1, wherein monitoring an aspect of a liquid retained in the mobile liquid tank comprises monitoring an aspect of the liquid with at least one sensor disposed in the mobile liquid tank.

13. The method according to claim 12, wherein monitoring an aspect of the liquid with at least one sensor disposed in the mobile liquid tank comprises monitoring an aspect of the liquid with a pressure sensor or a motion sensor disposed in the mobile liquid tank.

14. The method according to claim 11, wherein predicting expected motion of the liquid retained in the mobile liquid tank based on the monitored aspect of the liquid comprises predicting expected motion of the liquid with a control unit in communicative contact with the at least one sensor.

15. The method according to claim 14, wherein predicting expected motion of the liquid with a control unit in communicative contact with the at least one sensor comprises calculating the expected motion of the liquid by feeding information from the at least one sensor to a computer running a liquid movement modeling program.

16. The method according to claim 15, wherein calculating the expected motion of the liquid by feeding information from the at least one sensor to a computer running a liquid movement modeling program using a marker and cell calculation technique.

17. The method according to claim 15, wherein calculating the expected motion of the liquid by feeding information from the at least one sensor to a computer onboard a prime mover attached to a trailer on which the mobile liquid tank is mounted.

18. The method according to claim 14, wherein inflating at least pneumatic airbag to raise a portion of the mobile liquid tank to counter the predicted expected motion of the liquid comprises actuating at least one valve in communicative contact with the control unit.

19. The method according to claim 14, wherein predicting expected motion of the liquid with a control unit in communicative contact with the at least one sensor further comprises predicting expected motion of the liquid with the control unit in communication with at least one sensor disposed on a carrier to which the mobile liquid tank is mounted for sensing motion of the carrier.

20. The method according to claim 1 1, wherein predicting expected motion of the liquid retained in the mobile liquid tank based on the monitored aspect of the liquid further comprises predicting the likelihood of the mobile liquid tank to rollover; and deflating the at least pneumatic airbag to lower the center of gravity of the mobile liquid tank to counter the predicted likelihood of rollover.
